(19) United States
(12) Patent Application Publication
(10) Pub. No.: US 2024/0360848 A1
(43) Pub. Date: Oct. 31, 2024

(54) DOUBLE ACTING HITCH HYDRAULIC VALVE ASSEMBLY

(71) Applicant: Deere & Company, Moline, IL (US)

(72) Inventor: Michael A. Holland, Cedar Falls, IA (US)

(73) Assignee: Deere & Company, Moline, IL (US)

(21) Appl. No.: 18/498,518

(22) Filed: Oct. 31, 2023

Related U.S. Application Data
(60) Provisional application No. 63/498,048, filed on Apr. 25, 2023.

(51) Int. Cl. F15B 11/028; B60D 1/62

(52) U.S. Cl. CPC F15B 11/028; B60D 1/62; F15B 2211/3056; F15B 2211/50509

(57) ABSTRACT

One or more techniques and/or systems are disclosed for a hydraulic system that is used with a vehicle hitch, to raise and lower an implement attached to the hitch. The system has a lifting side, that raises the hitch, and a downforce side that applies downward pressure. Hydraulic actuators are used to apply the up or down force using supply lines coupled to both sides. A downforce pressure control valve controls an amount of hydraulic pressure is supplied to the downforce side. A mode select valve is fluidly coupled to the downforce pressure control valve and is used to select hitch operation between a double acting hitch position, a single acting hitch position, and a neutral position. A work port check valve is between the downforce side and the mode select valve to stop the fluid from flowing back into the system when de-energized or in the neutral position.

### BACKGROUND

Work vehicles, such as agricultural tractors, and construction vehicles, often tow, pull, or otherwise operate implements, such as seeders, plows, graders, etc. The vehicles typically use a hydraulically powered hitch to raise and lower the hitch so that it is operating at a desired position, and to counteract the weight of the implement in these positions. There are two basic hydraulic systems. The single acting only provides for upward or lifting force, and gravity is used to lower the hitch. In single acting, hydraulic power is provided to a lifting side of a cylinder to push up the hitch, and fluid drains to a return line to lower the hitch. In double acting, hydraulic power is provided to both sides of the cylinder, to the lift and downforce sides.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are described herein for a hydraulic system that is used with a vehicle hitch, such as to raise and lower an implement attached to the hitch. Such a system can have a lift side, that raises the hitch, and a downforce side that applies downward pressure to the hitch. Hydraulic actuators, such as cylinders, can be used to apply the up or down force, where pressure lines are coupled to both sides to provide the force. With an upward force on the hitch (“negative tongue weight”) and in a neutral position, hydraulic fluid can flow back into the system, such as through a return line, which would raise the hitch uncontrollably. As described herein, a work port check valve can be placed between the downforce side of the actuators and a mode select valve to stop the fluid from flowing back into the system when it is de-energized or in the neutral position. The mode select valve engages the work port check valve and is used to select between a double action (up and down force), single action (up force only, gravity down), or neutral.

In one implementation of a system for a hydraulic system for a vehicle hitch, a hydraulic actuator can comprise a lift side and a downforce side, where respective lift side and downforce side are fluidly coupled with a hydraulic supply line. In this implementation, a downforce pressure control valve can be fluidly coupled to the supply line, and the downforce pressure control valve can be configured to control an amount of pressure supplied to the downforce side. Further, a mode select valve can be fluidly coupled with the supply line between the downforce pressure control valve and the hydraulic actuator and can be fluidly coupled to a hydraulic return line. The mode select valve can be configured to select hitch operation between a double acting hitch position, a single acting hitch position, and a neutral position. Additionally, a work-port check valve can be fluidly coupled with the supply line between the mode select valve and the hydraulic actuator. The work-port check valve can be configured to mitigate hydraulic fluid flow back toward the mode select valve from the downforce side when the mode select valve is disposed in the neutral position.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1A is a schematic diagram illustrating an example implementation of a hydraulic system in accordance with one or more systems described herein.

FIG. 1B is a schematic diagram illustrating one implementation of an example portion of a hydraulic system in accordance with one or more systems as described herein.

FIG. 1C is a schematic diagram illustrating one implementation of an example portion of a hydraulic system in accordance with one or more systems as described herein.

FIGS. 2A, 2B, and 2C are component diagram illustrating one example implementation of one or more portions of one or more systems as described herein.

FIG. 3 is a component diagram illustrating one example implementation of a vehicle or implement that may utilize the hydraulic system described herein.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

In one aspect, the innovative concept relates to hydraulics and rear implement (e.g., and front implement) connections for work vehicles, such as tractors. The innovative hydraulic circuit, disclosed herein, improves a mode-selectable single acting/double acting hitch with low pressure drop. The double acting hitch feature enables: a shorter time-to-depth in certain soil-engaging implements, by providing positive downforce; reduced integral planter weight by allowing tractor weight to be transferred to an integral planter via downforce; and for a drawn planter to be pulled by the tractors hitch draft links, even when the planter weight shifts to apply a negative tongue weight to the tractor.

The innovative hydraulic circuit allows for maintaining of implement position (e.g., up/down) under a negative tongue weight applied to the vehicle, even when the hydraulic circuit is de-energized. That is, for example, existing hydraulic circuits allow for upward drift of the implement under negative town weight when the circuit is de-energized. In this example, the circuit described herein can provide a position-holding mode when the tractor is de-energized. That is, in this example, whether the implement applies positive (downward) tongue weight on the hitch linkages or the implement applies negative (upward) tongue weight, the hitch position can remain substantially constant using low leak check valves disposed in the hydraulic circuit.

The innovative hydraulic circuit described herein relates to a double acting hitch system, which may be deployed at a rear or front hitch of a work vehicle, such as a tractor. In a rear hitch system, a typical configuration is to lift the implement with the cap side of the actuator. That is, the lift coupling mechanisms of the hitch may be fixed to the cap side of the hydraulic actuator. In this implementation, the rod side of the actuator can be used to push the hitch linkage down (e.g., apply downforce), where the rod is fixed to lowering mechanisms of the hitch. However, in some implementations, the arrangement can be reversed, where the cap side is used for lowering and the rod side is used to raise the implement.

In some implementations, the arrangement of the valves in the hydraulic circuit provides for the advantages over existing systems, as described herein. In some implementations, a mode select valve opens and holds open a work port check in either double acting (DA) or single acting (SA) modes. Further, an intermediate position is used at power off (e.g., circuit de-energization) that allows a work port check disposed on a lowering-side (e.g., rod-side) of the hydraulic actuator to hold a potential upward force from the implement (e.g., negative tongue weight) from acting on the hitch assembly, mitigating drift.

In the system described herein, the lift side (e.g., cap side) of the hitch lift, hydraulic actuators are hydraulically connected to a typical hitch valve. This type of hitch valve is typically used by both a single acting hitch and a selectable (e.g., single acting/double acting) hitch downforce system. As an example, if sufficient pressure is maintained in the lift side of the hitch actuators (e.g., as a result of weight on the hitch, downforce control, or a combination of the two), the hitch valve can control the lifting and lowering velocity of the hitch. This lift and lower velocity control is accomplished as the typical hitch valve is a flow control valve.

In the innovative system described herein, control of the lowering side (e.g., rod side) differs from existing system to provide for the double acting hitch function. In some implementations, an electrohydraulic pressure control valve (e.g., pressure reducing/relieving valve) can regulate pressure to the lowering side of the hitch lift actuators to provide downforce through the hitch linkages to the implement. In this implementation, the pressure control of the lowering side can be communicated through a mode select valve to establish a single acting or a double acting mode. Additionally, the mode select valve operates a mechanically actuated work-port check valve to provide for the mitigation of negative tongue weight drift when the circuit is de-energized.

In some implementations, a mechanical linkage is provided between a spool in the mode select and a mechanically operated work-port check valve. As an example, to achieve the to select between modes, the spool of the mode select valve is translated (e.g., up or down) to connect the pressure control valve to the lowering side of the actuator via the work-port check (e.g., double acting (DA) mode), or the lowering side of the actuator to the sump or tank (e.g., single acting (SA) mode). As an example, a ramp on the mode select spool operably translates a pushrod connecting to the work-port check valve, which moves a small check valve from closed to open, in the work-port check valve poppet. This opening of the poppet allows for equalization of pressure across the work-port check, and flow between appropriate locations (e.g., pressure control valve or sump).

In one example, when the mode select valve spool translates to the double acting mode position, the pushrod maintains the poppet in an open position, to open the work port check, which is held open mechanically. In this example, the geometry of the spool fluidly opens the desired path between the lowering side of the actuator and the pressure control valve and seals the path to the sump. Further, to achieve the single acting mode, the mode select valve is shifted to fluidly connect the lowering side of the actuator to the tank/sump via the work port check and seal the path to the pressure control valve. For example, a second ramp on the mode select spool translates the pushrod, again, moving open the check valve in the work port check valve poppet to equalize pressure across the work port check. In this example, as the spool continues to translate to the single acting mode position, the pushrod further opens the work port check, which is then held open mechanically.

Additionally, as described in further detail below, in some implementations, when the mode select valve actuator is de-energized (e.g., providing neither DA or SA selection), the mode select valve can shift to an intermediate or neutral position. This position allows the work-port check valve to block fluid in the line coupled to the lowering side of the hydraulic actuator from flowing toward the mode select valve, which can hold an upward load without a control effort from the vehicle. As an example, this position can be a default or normal state. In this aspect of the innovation described herein, the use of a spool type mode select valve enables a low pressure drop between the lowering side of the hitch actuator and a pressure reducing valve (DA mode), or for a return path from the lowering side to the tank/sump (SA mode). In this aspect, the low-pressure drop can limit the reduction in hitch lifting power in either DA or SA modes.

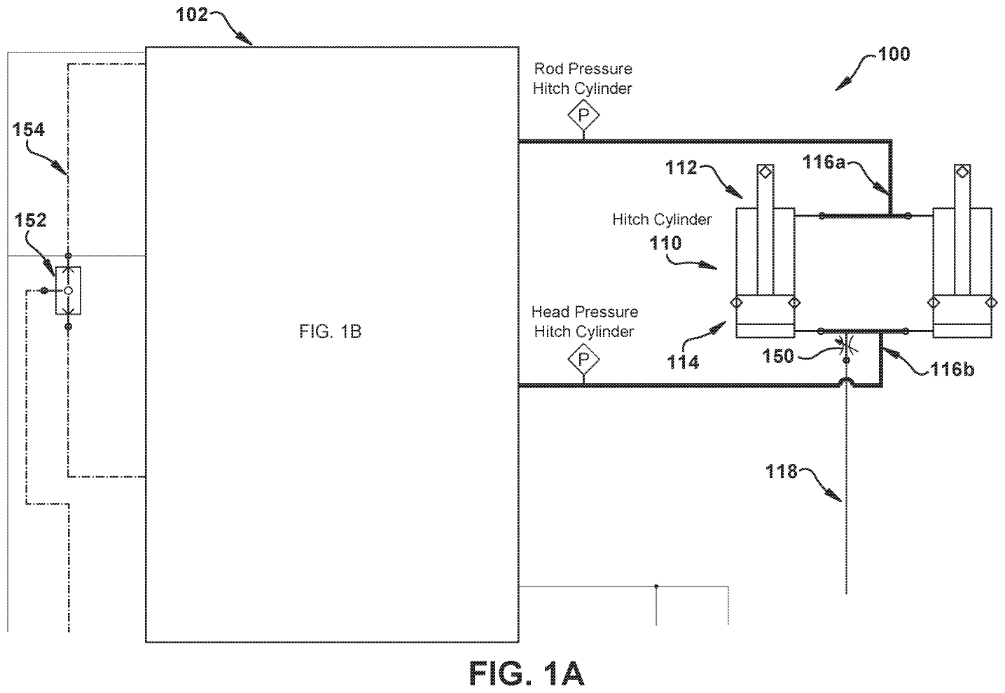

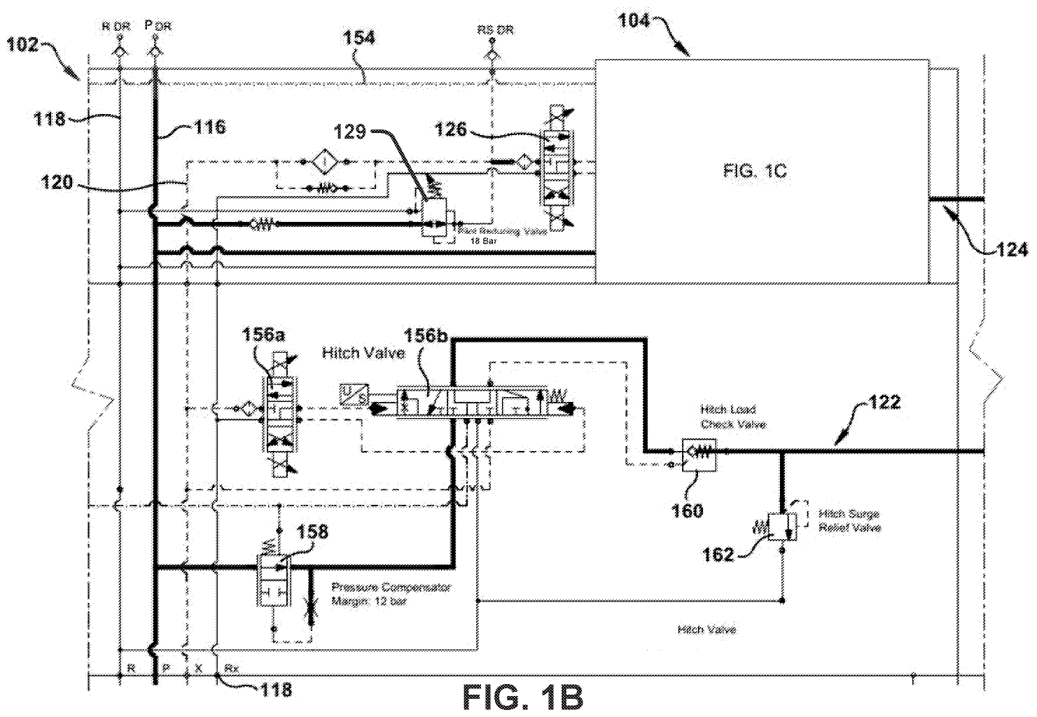

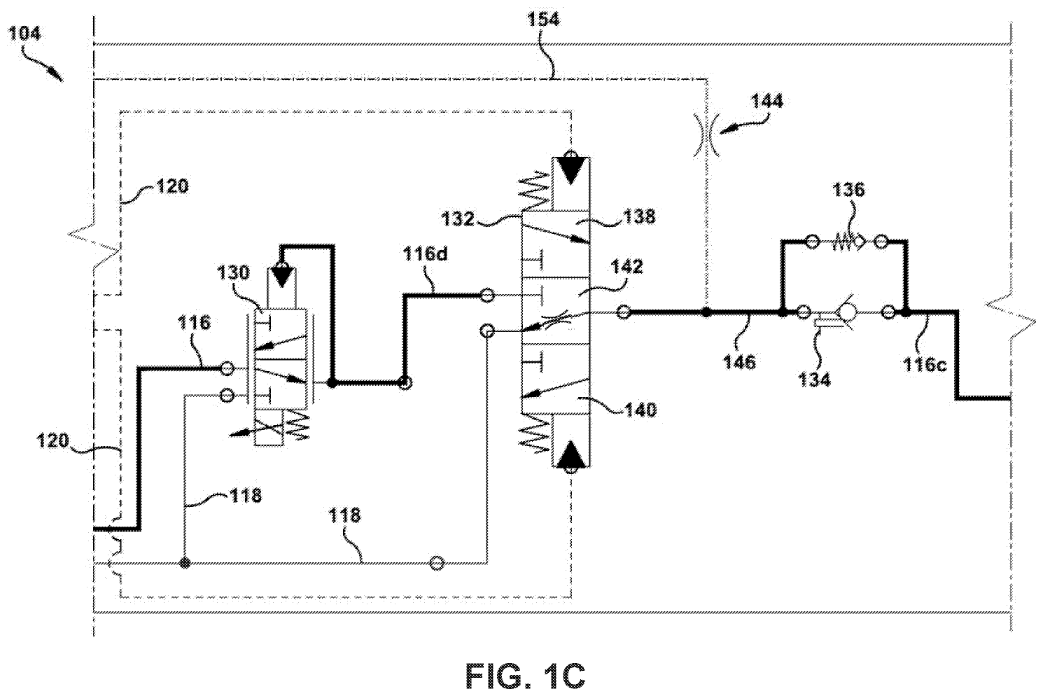

FIGS. 1A, 1B, and 1C are schematic diagrams illustrating portions of a hydraulic circuit 100, which can be used to operate hydraulic actuators (e.g., cylinders), such as for a vehicle hitch system. In this example implementation, in FIG. 1A, a pair of hydraulic actuators 110 (e.g., hitch cylinders) are fluidly coupled with the circuit 100. In this example, a downforce or lowering side 112 of the actuator 110 comprises the rod side; and a lift or raising side 114 comprises the cap or head side. However, in alternate implementations, as described above, the lowering side 112 can comprise the cap side and the lifting side 114 can comprise the rod side. Further, respective actuators 110 are coupled to hydraulic pressure or hydraulic supply line 116a, 116b respectively at each end 112, 114; and a hydraulic fluid return line 118 (e.g., to sump/tank) is coupled to the pressure lines 116 via a pressure relief valve 150. A shuttle valve 152 and lines 154 are coupled to the system 100, for example, to detect pressure at desired locations in the system. As an example, using the shuttle valve 152, the higher value of the two sensed pressures (e.g., hitch lift or hitch downforce) is selected and the value is communicated to the rest of the load sense system. In this example, the load sense pressure value is communicated to the controller of a pressure and flow compensated pump.

In this example implementation, in FIG. 1B, a close-up view of a section 102 of the hydraulic circuit 100 is illustrated. In this example, the circuit 100 comprises the signal lines (load sense) 154, pressure or hydraulic supply lines 116, hydraulic fluid return lines 118, and low-pressure control lines 120 or pilot control lines (as explained in more detail below). As an example, the pressure in the pilot lines 120 (low pressure control) can be set by the pilot pressure reducing valve 129. In this example, that setting is established by a spring with a pre-set value (e.g., 18 bar shown). The pilot supply 120, in this example, is pre-set to 18 bar, referenced to return. That is, the pilot supply value is the return pressure plus 18 bar, in this example, The low-pressure control lines are configured to provide fluid at relatively low pressure for controlling valves (e.g., piloted valve spool positions). Typical hydraulic circuitry may be disposed on a lift or raise portion 122 of the hydraulic circuit 100, which leads to the pressure supply 116b of the lift end 114 of the hydraulic actuators 110. That is, for example, a series of pilot valves 156, pressure compensators 158, check valves 160, and relief valves 162 can be used to control supply to the pressure supply 116b of the lift end 114 of the hydraulic actuators 110. Further, the lift or raise portion 122 comprises fluidly coupled supply 116, return 118, and low-pressure control lines, along with the pressure signal line 154.

In this example, on a lowering or downforce side 124 of the hydraulic circuit 100, which leads to pressure supply line 116a, leading to the lowering end 112 (e.g., rod end) of the hydraulic actuator 110, the innovative hydraulic circuit 104 can be disposed. Further, on the lowering or downforce side 124 of the hydraulic circuit 100, a mode select pilot valve 126 is fluidly coupled to the hydraulic pressure supply line 116 between a downforce pressure control valve 130 and the hydraulic actuator 110, and is also fluidly coupled to the return line 118. The mode select pilot valve 126 provides a low-pressure control signal 120 to the innovative circuit 104, at the mode select valve 132, described below. In this way, the mode select pilot valve 126 operably provides pilot hydraulic fluid 120 to the mode select valve 132 to select a hitch operation between a double acting hitch position, a single acting hitch position, and a neutral position.

FIG. 1C schematically illustrates the innovative hydraulic circuit 104. In this implementation, the example portion of the circuit 104 comprises a downforce pressure control valve 130, a mode select valve 132, and a work-port check valve 134. In some implementations a thermal relief valve 136 can be disposed on the hydraulic pressure supply line 116, to provide for relief at a predetermined pressure.

In this example, the downforce pressure control valve 130 is fluidly coupled to the hydraulic supply line 116, and can be used to control an amount of fluid pressure supplied to the downforce side 124 (FIG. 1B) of the circuit 100, thereby controlling the amount of pressure provided to the downforce or lowering side 112 of the actuator 110. The mode select valve 132 is disposed on the actuator side of the downforce pressure control valve 130 and is fluidly coupled to the downforce pressure control valve 130 by a supply line 116d. The mode select valve 132 is also fluidly coupled to a return line 118. The mode select valve 132 can be used to select hitch operation between a double acting 138, single acting 140, or neutral position 142. Further, a low-pressure pilot signal 120 leads to respective ends of the mode select pilot valve 126 and can be used to select the position of the mode select valve 132.

The work-port check valve 134 is disposed on the actuator side of the mode select valve 132, and fluidly coupled to the mode select valve 132 by a pressure supply line 146, which can provide an LS signal. The work-port check valve 134 is fluidly coupled with the supply line 116 between the mode select pilot valve 126 and the hydraulic actuator 110. In some implementations, the work-port check valve 134 may be directly fluidly engaged with the mode select valve 132. In some implementations, a pressure signal line 154 can be engaged with the pressure line 116 at an actuator side of the mode select valve 132 to detect pressure in this line. The work-port check valve 134 can comprise a valve (e.g., a poppet valve) that can be selectively opened to adjust fluid routing between the mode select valve 132 and the pressure supply line 116c, as will be described in further detail below. Additionally, in some implementations, an orifice 144 can be disposed on the pressure signal line 154. In these implementations, the orifice 144 can provide damping, and when disposed at this location, can improve stability of the hydraulic system 100. The work-port check valve 134 can operably mitigate hydraulic fluid flow toward the mode select valve 132 from the downforce side 112 when the mode select valve 132 is disposed in the neutral position 142, and/or when the system is deactivated.

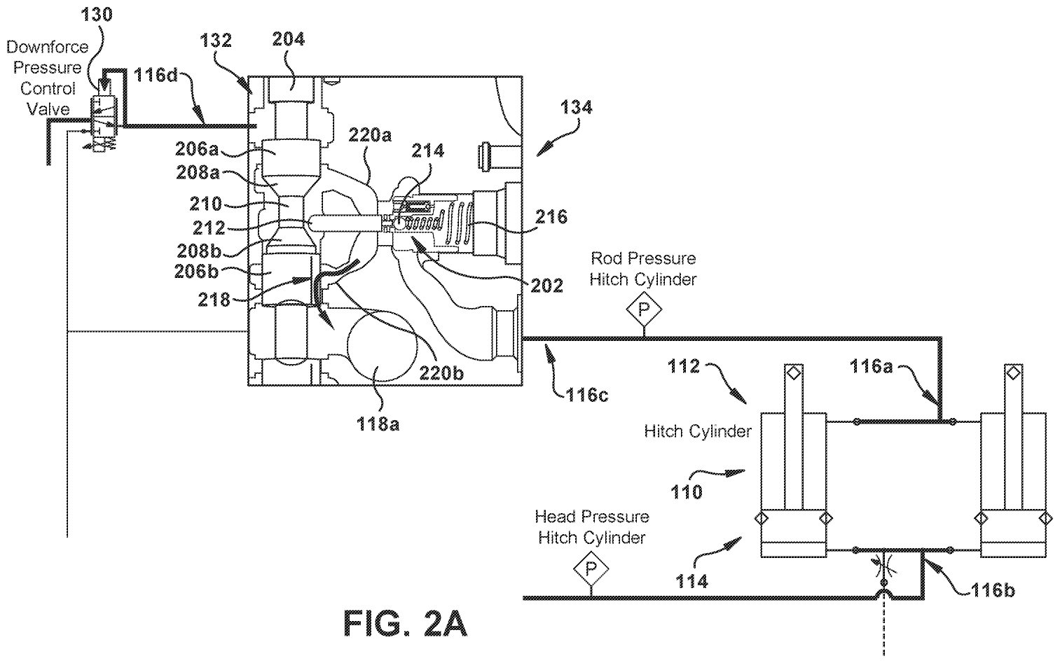

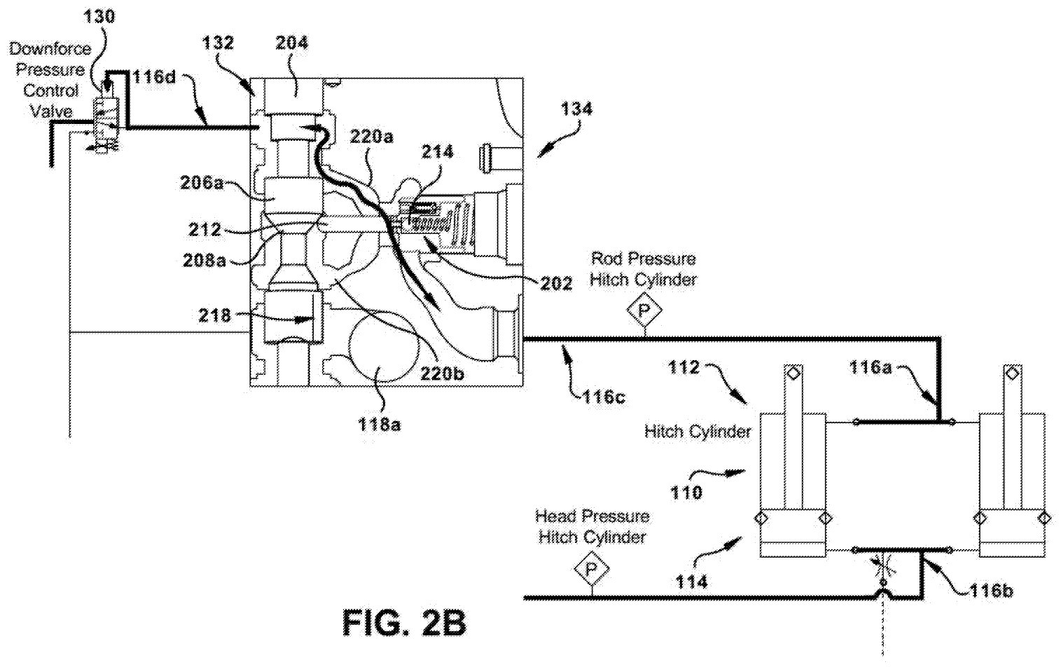

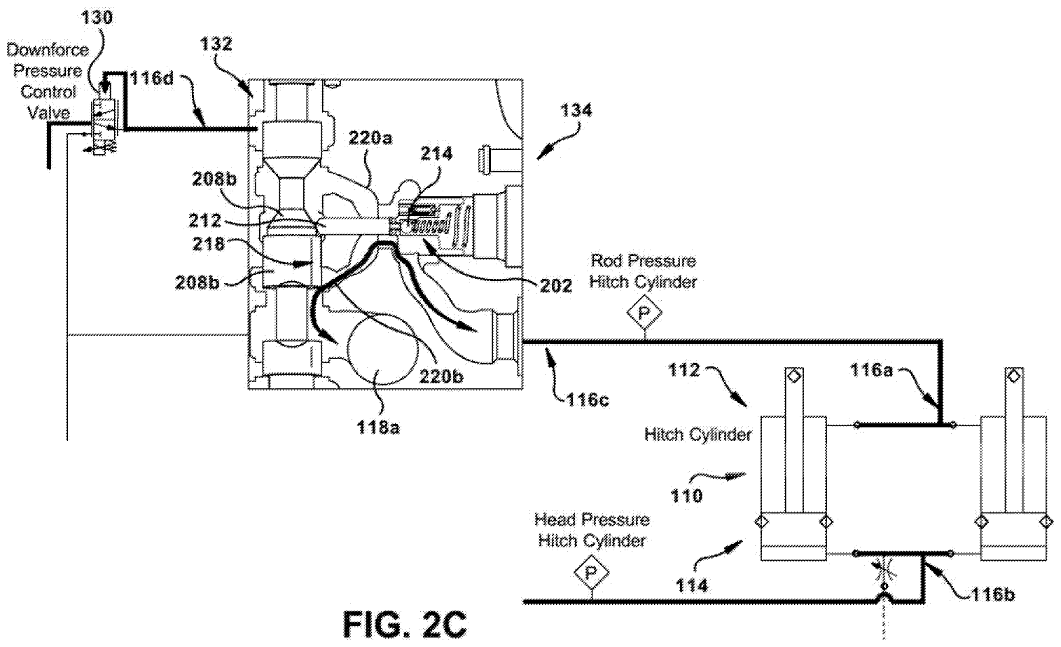

FIGS. 2A, 2B, and 2C are schematic diagrams that illustrate an example implementation of the portion 104 of the hydraulic circuit 100, as coupled with the hydraulic actuators 110. As illustrated, the downforce pressure control valve 130 is fluidly coupled with the mode select valve 132 by a pressure supply line 116d. The mode select valve 132 is fluidly coupled with the work-port check valve 134 at a poppet valve 202. Although, in some implementations, as described above, the mode select valve 132 and work-port check valve 134 could also be coupled by a pressure supply line (e.g., 116). Further, the work-port check valve 134 is fluidly coupled with the lowering or downforce side 112 of the actuators 110 by a pressure supply line 116c (e.g., via 116a).

As illustrated, the mode select valve 132 comprises a mode select spool 204, having a geometry that comprises lands 206, ramps 208, and a neutral position 210. The mode select spool 204 operably translates along a longitudinal axis of the mode select valve 132, which is operated by the control pilot fluid 120 provided from the mode select pilot valve 126. That is, for example, the select spool 204 of the mode select valve 132 can have pilot pressure 120 applied to the ends of the spools to actuate the valve 132. The mode select spool 204 comprises a first ramp 208a leading to a first land 206a, a second ramp 208b leading to a second land 206b, and a valley land 210 continuous with and disposed between the first ramp 208a and second ramp 208b. The mode select spool 204 is configured to be translated back and forth (e.g., up and down) in the mode select valve 132, which can be controlled by the low-pressure, hydraulic control line 120, or may be controlled by an actuator (e.g., a mechanical, or electro-mechanical actuator). Further, a pushrod or follower 212 (e.g., mechanical sensor) can be disposed between and in engagement with the mode select spool 204 and the work-port check valve 134. Here, the sensor 212 can operably translate orthogonally to the longitudinal axis of the mode select spool 204 when displaced by the first ramp 208a and second ramp 208b. In some implementations, the sensor 212 can be disposed between and in engagement with the mode select spool 204 and the poppet valve 202, such that translation of the pushrod or follower 212 by way of the ramps 208 and lands 206 directly results in an opening or closing of the poppet valve 202. Further, in some implementations, the back pressure from the downforce side 112 can provide a closing force to the poppet valve 202.

That is, for example, the poppet valve 202 can comprise a check ball 214 (e.g., check valve, or the like) that is in direct engagement with a portion of the pushrod or follower 212. In this example, when the pushrod or follower 212 is translated toward the work-port check valve 134 (e.g., to the right in the FIGURES), the check ball 214 will also translate in the same direction. Further, in some implementations, the poppet valve 202 will be held in a normally close position (as illustrated in FIG. 2A) and can be biased in that position by a spring 216. In some implementations, the poppet valve 202 will be held in a normally close position by back pressure provided by the supply line 116c, described further below.

As illustrated in FIG. 2A, the mode select spool 204, and thus the mode select valve 132 is disposed in a neutral position, or otherwise de-energized position. For example, when the hydraulic circuit 100 is de-energized, such as when the vehicle is de-energized, the mode select valve 132 can default to the neutral position. In this implementation, the pushrod or follower 212 (e.g., a position sensor) is in contact with the neutral portion 210 of the mode select spool 204 on the shaft. As such, the check ball 214 in the poppet valve 202 is also disposed in the normal (closed) position, such that fluid communication between the mode select valve 132 and pressure supply line 116c is closed. Further, in this position, the land 206a of the mode select spool 204 closes fluid communication between the pressure supply line 116d and an upper portion 220b of an internal passage 220 of the mode select valve 132. Additionally, the mode select spool 204 comprises a spool leakage notch or groove 218 that is positioned in a lower portion 220b of the internal passage 220 to allow fluid transit or relief to a return line 118a to allow for thermal relief, and as a bleed function for venting a blocked condition, such as when the mode select spool 204 is positioned in the neutral position.

Of note, for example, when an implement is positioned on the hitch and is providing for a negative weight on the tongue, the downforce side 112 of the actuators 110 will be under pressure, which would normally lead to an uncontrolled lifting of the hitch (e.g., and rod). However, in this implementation, the pressure provided by the backpressure on the supply lines 116a, 116c provides for pressure on the poppet valve 202, which forces the ball check 214 and poppet 202 into the closed position. In this way, in this example, pressure is maintained in the supply lines 116c. 116a, and at the downforce side 112 of the actuators. This maintaining of pressure while the spool 204 is in the neutral or de-energized position provides to maintaining the hitch in the hold position. This mitigates the uncontrolled lifting of the hitch, which would occur in prior systems.

FIG. 2B illustrates the example spool 204 disposed in the double acting mode. As illustrated, the spool 204 has been translated downward, such that the pushrod or follower 212 is disposed on the ramp 208a. In this position, the pushrod or follower 212, in contact with the check ball 214, opens the poppet valve 202 to allow a fluid connection between the pressure line 116c and the top portion 220a of the internal passage 220. As described in more detail below, for example, if there is pressure holding the work port 202 shut, the pushrod sensor 212 opens the small check valve 214 (e.g., ball) before the spool 204 timing connects the passages 220a. 116c. In this example, this opening and timing can equalize the pressure across the poppet (202). Further, in this example, as the pushrod sensor 212 continues to push/hold the work-port check valve 202 open as the spool (204) translates. Further, the movement of the land 206a has opened fluid communication between the top portion 220a of the internal passage 220 and the pressure supply line 116d. In this way, fluid communication is opened between the downforce pressure control valve 130 and the downforce portion 112 of the hitch actuators 110. As such, in this example, downforce action can be provided to the hitch actuators 110 (e.g., providing the double action).

Additionally, the slot/groove 218 is now closed off from communication with the lower portion 220b of the internal passage 220, and the return line 118a is also closed off from fluid communication with the internal passage 220. In this way, only fluid communication between the downforce pressure control valve 130 and the downforce portion 112 of the hitch actuators 110, and the return line 118 is closed off. In some implementations, the spool 204 can be further translated downward such that the pushrod or follower 212 is disposed on the land 206a, which can open the poppet valve 202 even further. In some implementations, the slot/groove 218 could remain open. In these implementations, this could provide a potential leakage path that may be used to provide hydraulic stability. That is, for example, providing some leakage to the return tank/sump can help to stabilize the pressure control circuit.

FIG. 2C illustrates the example spool 204 disposed in the single acting mode. As illustrated, the spool 204 has been translated upward (e.g., from the neutral position of FIG. 2A), such that the pushrod or follower 212 is disposed on the ramp 208b. In this position, the pushrod or follower 212, in contact with the check ball 214, opens the poppet valve 202 to allow a fluid connection between the pressure line 116c and the bottom portion 220b of the internal passage 220. Further, the movement of the land 206a has closed fluid communication between the top portion 220a of the internal passage 220 and the pressure supply line 116d. Additionally, the movement of the land 206b has opened the fluid passage between the lower portion 220b and the return line 118a. In this way, fluid communication is opened between the downforce portion 112 of the hitch actuators 110 and the return line 118a (e.g., back to the tank). As such, in this example, no downforce action is provided to the hitch actuators 110, and merely a single action is provided. As such, for example, deactivating pressure to the lift side 114 of the actuators 110 will merely allow the fluid to drain to the return line from the downforce side 112. The spool 204 may be further translated downward such that the pushrod or follower 212 is disposed on the land 206a, which can open the poppet valve 202 even further.

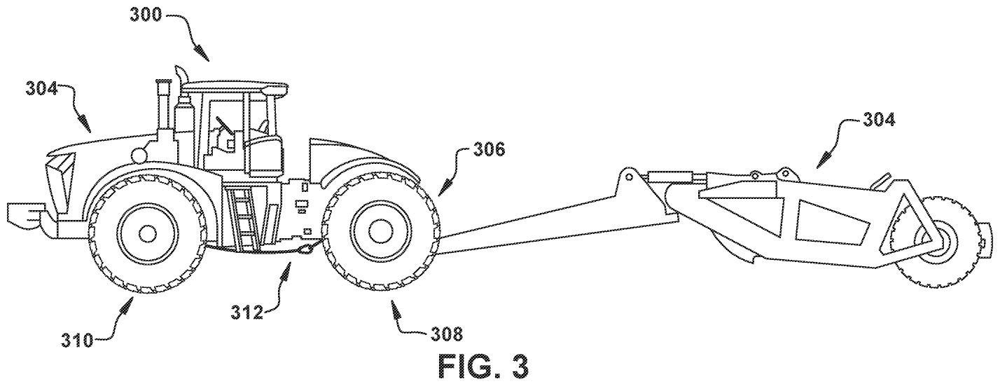

FIG. 3 is a component diagram illustrating an example implementation of a system that may utilize one or more portions of the innovative concepts described herein. In this implementation, as illustrated in FIG. 3, a vehicle 302, such as a tractor (e.g., or similar), can be coupled with a working implement 304, such as a scraper or any other implement that attaches to a working vehicle. In this implementation, for example, the implement 304 can be towed behind the vehicle 302 during a working operation, such as in a field, construction site, etc. In some implementations, as illustrated, the vehicle 302 may have wheels installed at front 110 and rear 108 axles. In other implementations the vehicle 302 may have track systems installed on the rear or both the front and rear instead of wheels. Further, the implement 304 can be coupled to the vehicle at a coupling 306, such as using a hitch coupled with a drawbar or implement tongue.

As one example, the vehicle 302, such as a tractor, can be attached to the implement 304 to perform target operations, such as ground leveling, harvesting, hauling, cutting, etc. In this example, the tractor can utilize the implement 304 for its intended purpose and, using the innovative hydraulic systems 312 described herein, may raise and lower the hitch during use, or before and after use (e.g., for set-up or storage). For example, when attaching the implement 304 the operator may use the hydraulic system 312 to raise or lower the coupling 306 in order to attach the implement 304 to the coupling 306. During use, the operator may wish to raise or lower the implement 306 (e.g., a scraper to pull more or less dirt), which can be performed by the hydraulic system 312 raising or lowering the coupling 306. Further, when the tractor 302 is stored, and the hydraulic system 312 is shut off, the coupling 106 can remain at the position is located at shut-off, instead of raising or lowering do to back flow of hydraulic fluid.

While this example describes a tractor coupling with one or more scrapers, it should be appreciated that the systems and methods described herein may also be utilized with other types of vehicles and implements. For example, the vehicle may comprise another utility-type vehicle, such as a truck, hauler, semi-tractor, or any vehicle that tows an implement that may apply a downward vertical force on the coupling point. Further, for example, the implement may comprise a planter, seeder, tillage implement, grain carts, graders, and other implements that can apply a varying amount of vertical downward force on the coupling with the towing vehicle.

Described implementations of the subject matter can include one or more features, alone or in combination.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

### EXAMPLE EMBODIMENTS

The following are example embodiments of the innovation described herein:

Embodiment one is a hydraulic system for a vehicle hitch assembly, comprising: a hydraulic actuator comprising a lift side and a downforce side, respective lift side and downforce sides fluidly coupled with a hydraulic supply line that operably supplies hydraulic fluid; a downforce pressure control valve fluidly coupled to the hydraulic supply line, the downforce pressure control valve operably controlling an amount of fluid pressure is supplied to the downforce side; a mode select valve fluidly coupled with the supply line between the downforce pressure control valve and the hydraulic actuator, and fluidly coupled to a hydraulic return line, the mode select valve operably selecting hitch operation between a double acting hitch position, a single acting hitch position, and a neutral position; and a work-port check valve fluidly coupled with the supply line between the mode select valve and the hydraulic actuator, the work-port check valve operably mitigating hydraulic fluid flow toward the mode select valve from the downforce side when the mode select valve is disposed in the neutral position.

Embodiment two is a system of embodiment one, wherein the work-port check valve operably mitigates hydraulic fluid flow toward the mode select valve from the downforce side when the system is deactivated.

Embodiment three is a system of embodiment one, wherein the mode select valve comprises a mode select spool that operably translates along a longitudinal axis of the mode select valve, the mode select spool comprising a first ramp leading to a first land, a second ramp leading to a second land, and a valley land continuous with and disposed between the first ramp and second ramp.

Embodiment four is a system of embodiment three, wherein the mode select spool comprises a groove disposed on a surface of the second land, the groove operably providing for fluid transit from a passage in the mode select valve to the return line when the mode select spool is disposed in the neutral position.

Embodiment five is a system of embodiment three, further comprising a sensor comprising a rod disposed between and engaged with the mode select spool and the work-port check valve, the sensor operably translating orthogonally to the longitudinal axis of the mode select spool when displaced by the first ramp and second ramp.

Embodiment six is a system of embodiment five, wherein the work-port check valve comprises a poppet valve engaged with the sensor, the poppet valve moving between an open position and closed position when displaced by the sensor.

Embodiment seven is a system of embodiment five, wherein the supply line between the downforce pressure control valve and the hydraulic actuator is fluidly coupled with the supply line between the work-port check valve and the downforce side when the sensor is engaged with the first ramp and/or first land.

Embodiment eight is a system of embodiment five, wherein the supply line between the work-port check valve and the downforce side is fluidly coupled with the return line of the mode select valve when the sensor is engaged with the second ramp and/or second land.

Embodiment nine is a system of embodiment one, wherein the work-port check valve comprises a poppet valve that is normally biased to a closed position.

Embodiment ten is a system of embodiment one, wherein the work-port check valve comprises a poppet valve that is disposed in a closed position when the mode select valve is disposed in a neutral position.

Embodiment eleven is a system of embodiment ten, wherein back pressure from the downforce side provides a closing force to the poppet valve.

Embodiment twelve is a system of embodiment one, wherein the hitch operation is operably selected in the mode select valve by a hydraulic actuator, mechanical actuator, or electro-mechanical actuator.

Embodiment thirteen is a system for a vehicle hitch assembly, comprising: a sump that holds hydraulic fluid that is fluidly coupled with and provides hydraulic fluid to a supply line, and fluidly coupled with and receives fluid from a return line; a mode select valve that operably select between operations of the hitch assembly, comprising a double acting hitch position, a single acting hitch position, and a neutral position; a hydraulic actuator comprising a lift side and a downforce side that are fluidly coupled with the supply line downstream from the mode select valve; a downforce pressure control valve fluidly coupled to the hydraulic supply line upstream from the mode select valve, the downforce pressure control valve controlling an amount of fluid pressure supplied to the downforce side; and a work-port check valve fluidly coupled with the supply line upstream from the hydraulic actuator, the work-port check valve operably mitigating hydraulic fluid flow toward the mode select valve from the downforce side when the mode select valve is disposed in the neutral position.

Embodiment fourteen is a system of embodiment thirteen, wherein the work-port check valve mitigates hydraulic fluid flow toward the mode select valve from the downforce side when the system is deactivated.

Embodiment fifteen is a system of embodiment thirteen, wherein the mode select valve comprises a mode select spool that operably translates along a longitudinal axis of the mode select valve, the mode select spool comprising a first ramp leading to a first land, a second ramp leading to a second land, and a valley land continuous with and disposed between the first ramp and second ramp.

Embodiment sixteen is a system of embodiment fifteen, further comprising a sensor comprising a rod disposed between and engaged with the mode select spool and the work-port check valve, the sensor operably translating orthogonally to the longitudinal axis of the mode select spool when displaced by the first ramp and second ramp.

Embodiment seventeen is a system of embodiment sixteen, wherein the work-port check valve comprises a poppet valve engaged with the sensor, the poppet valve moving between an open position and closed position when displaced by the sensor.

Embodiment eighteen is a system of embodiment thirteen, wherein the work-port check valve comprises a poppet valve that is normally biased to a closed position.

Embodiment nineteen is a system of embodiment thirteen, wherein the work-port check valve comprises a poppet valve that is disposed in a closed position when the mode select valve is disposed in a neutral position, and wherein back pressure from the downforce side provides a closing force to the poppet valve.

Embodiment twenty is a hydraulic system for a vehicle hitch assembly, comprising: a hydraulic actuator comprising a lift side and a downforce side, respective lift side and downforce sides fluidly coupled with a hydraulic supply line that operably supplies hydraulic fluid; a downforce pressure control valve fluidly coupled to the hydraulic supply line, the downforce pressure control valve operably controlling an amount of fluid pressure is supplied to the downforce side; a mode select valve fluidly coupled with the supply line between the downforce pressure control valve and the hydraulic actuator, and fluidly coupled to a hydraulic return line, the mode select valve operably selecting hitch operation between a double acting hitch position, a single acting hitch position, and a neutral position, the mode select valve comprising a mode select spool that operably translates along a longitudinal axis of the mode select valve, the mode select spool comprising a first ramp leading to a first land, a second ramp leading to a second land, and a valley land continuous with and disposed between the first ramp and second ramp; a sensor comprising a rod disposed between and engaged with the mode select spool and the work-port check valve, the sensor operably translating orthogonally to the longitudinal axis of the mode select spool when displaced by the first ramp and second ramp; and a work-port check valve fluidly coupled with the supply line between the mode select valve and the hydraulic actuator, the work-port check valve comprising a poppet valve engaged with the sensor, the poppet valve moving between an open position and closed position when displaced by the sensor to operably mitigate hydraulic fluid flow toward the mode select valve from the downforce side when the mode select valve is disposed in the neutral position and when the system is deactivated.

What is claimed is:

1. A hydraulic system for a vehicle hitch assembly, comprising:
a hydraulic actuator comprising a lift side and a downforce side, respective lift side and downforce sides fluidly coupled with a hydraulic supply line that operably supplies hydraulic fluid;
a downforce pressure control valve fluidly coupled to the hydraulic supply line, the downforce pressure control valve operably controlling an amount of fluid pressure is supplied to the downforce side;
a mode select valve fluidly coupled with the supply line between the downforce pressure control valve and the hydraulic actuator, and fluidly coupled to a hydraulic return line, the mode select valve operably selecting hitch operation between a double acting hitch position, a single acting hitch position, and a neutral position; and
a work-port check valve fluidly coupled with the supply line between the mode select valve and the hydraulic actuator, the work-port check valve operably mitigating hydraulic fluid flow toward the mode select valve from the downforce side when the mode select valve is disposed in the neutral position.

2. The system of claim 1, wherein the work-port check valve operably mitigates hydraulic fluid flow toward the mode select valve from the downforce side when the system is deactivated.

3. The system of claim 1, wherein the mode select valve comprises a mode select spool that operably translates along a longitudinal axis of the mode select valve, the mode select spool comprising a first ramp leading to a first land, a second ramp leading to a second land, and a valley land continuous with and disposed between the first ramp and second ramp.

4. The system of claim 3, wherein the mode select spool comprises a groove disposed on a surface of the second land, the groove operably providing for fluid transit from a passage in the mode select valve to the return line when the mode select spool is disposed in the neutral position.

5. The system of claim 3, further comprising a sensor comprising a rod disposed between and engaged with the mode select spool and the work-port check valve, the sensor operably translating orthogonally to the longitudinal axis of the mode select spool when displaced by the first ramp and second ramp.

6. The system of claim 5, wherein the work-port check valve comprises a poppet valve engaged with the sensor, the poppet valve moving between an open position and closed position when displaced by the sensor.

7. The system of claim 5, wherein the supply line between the downforce pressure control valve and the hydraulic actuator is fluidly coupled with the supply line between the work-port check valve and the downforce side when the sensor is engaged with the first ramp and/or first land.

8. The system of claim 5, wherein the supply line between the work-port check valve and the downforce side is fluidly coupled with the return line of the mode select valve when the sensor is engaged with the second ramp and/or second land.

9. The system of claim 1, wherein the work-port check valve comprises a poppet valve that is normally biased to a closed position.

10. The system of claim 1, wherein the work-port check valve comprises a poppet valve that is disposed in a closed position when the mode select valve is disposed in a neutral position.

11. The system of claim 10, wherein back pressure from the downforce side provides a closing force to the poppet valve.

12. The system of claim 1, wherein the hitch operation is operably selected in the mode select valve by a hydraulic actuator, mechanical actuator, or electro-mechanical actuator.

13. A hydraulic system for a vehicle hitch assembly, comprising:
a sump that holds hydraulic fluid that is fluidly coupled with and provides hydraulic fluid to a supply line, and fluidly coupled with and receives fluid from a return line;
a mode select valve that operably select between operations of the hitch assembly, comprising a double acting hitch position, a single acting hitch position, and a neutral position;
a hydraulic actuator comprising a lift side and a downforce side that are fluidly coupled with the supply line downstream from the mode select valve;
a downforce pressure control valve fluidly coupled to the hydraulic supply line upstream from the mode select valve, the downforce pressure control valve controlling an amount of fluid pressure supplied to the downforce side; and
a work-port check valve fluidly coupled with the supply line upstream from the hydraulic actuator, the work-port check valve operably mitigating hydraulic fluid flow toward the mode select valve from the downforce side when the mode select valve is disposed in the neutral position.

14. The system of claim 13, wherein the work-port check valve mitigates hydraulic fluid flow toward the mode select valve from the downforce side when the system is deactivated.

15. The system of claim 13, wherein the mode select valve comprises a mode select spool that operably translates along a longitudinal axis of the mode select valve, the mode select spool comprising a first ramp leading to a first land, a second ramp leading to a second land, and a valley land continuous with and disposed between the first ramp and second ramp.

16. The system of claim 15, further comprising a sensor comprising a rod disposed between and engaged with the mode select spool and the work-port check valve, the sensor operably translating orthogonally to the longitudinal axis of the mode select spool when displaced by the first ramp and second ramp.

17. The system of claim 16, wherein the work-port check valve comprises a poppet valve engaged with the sensor, the poppet valve moving between an open position and closed position when displaced by the sensor.

18. The system of claim 13, wherein the work-port check valve comprises a poppet valve that is normally biased to a closed position.

19. The system of claim 13, wherein the work-port check valve comprises a poppet valve that is disposed in a closed position when the mode select valve is disposed in a neutral position, and wherein back pressure from the downforce side provides a closing force to the poppet valve.

20. A hydraulic system for a vehicle hitch assembly, comprising:
a hydraulic actuator comprising a lift side and a downforce side, respective lift side and downforce sides fluidly coupled with a hydraulic supply line that operably supplies hydraulic fluid;
a downforce pressure control valve fluidly coupled to the hydraulic supply line, the downforce pressure control valve operably controlling an amount of fluid pressure is supplied to the downforce side;
a mode select valve fluidly coupled with the supply line between the downforce pressure control valve and the hydraulic actuator, and fluidly coupled to a hydraulic return line, the mode select valve operably selecting hitch operation between a double acting hitch position, a single acting hitch position, and a neutral position, the mode select valve comprising a mode select spool that operably translates along a longitudinal axis of the mode select valve, the mode select spool comprising a first ramp leading to a first land, a second ramp leading to a second land, and a valley land continuous with and disposed between the first ramp and second ramp;
a sensor comprising a rod disposed between and engaged with the mode select spool and the work-port check valve, the sensor operably translating orthogonally to the longitudinal axis of the mode select spool when displaced by the first ramp and second ramp; and
a work-port check valve fluidly coupled with the supply line between the mode select valve and the hydraulic actuator, the work-port check valve comprising a poppet valve engaged with the sensor, the poppet valve moving between an open position and closed position when displaced by the sensor to operably mitigate hydraulic fluid flow toward the mode select valve from the downforce side when the mode select valve is disposed in the neutral position and when the system is deactivated.
